(19) United States
(12) Patent Application Publication
(10) Pub. No.: US 2026/0340848 A1
(43) Pub. Date: Oct. 29, 2026

(54) LIGHT DETECTION DEVICE AND LIGHT DETECTION SYSTEM

(71) Applicant: SONY SEMICONDUCTOR SOLUTIONS CORPORATION, KANAGAWA (JP)

(72) Inventor: HISASHI YONEYAMA, KANAGAWA (JP)

(21) Appl. No.: 19/110,862

(22) PCT Filed: Aug. 17, 2023
(86) PCT No.: PCT/JP2023/029679

§ 371 Date: Mar. 12, 2025

(30) Foreign Application Priority Data
Sep. 21, 2022 (JP) 2022-150336

(51) Int. Cl. G06T 7/521; G01C 3/02; G06T 5/50; G06T 5/80; G06T 7/55; H04N 25/583; H04N 25/585

(52) U.S. Cl. CPC G06T 7/521; G01C 3/02; G06T 5/50; G06T 5/80; G06T 7/55; H04N 25/583; H04N 25/585

(57) ABSTRACT

[Problem] The present disclosure provides a light detection device and a light detection system capable of measuring a three-dimensional shape at a higher speed.

[Means of Solution] According to the present disclosure, a light detection device is provided, including: an image capturing part that captures an image of a measurement range onto which a projected image having a predetermined pattern is projected; and a signal processing part that generates three-dimensional distance data of the measurement range on the basis of first captured image data of a range that has a first dynamic range captured by the image capturing part, and second captured image data of a range that has a second dynamic range, different from the range of the first dynamic range. The signal processing part includes: a first processing part that extracts a first feature point on the basis of the first captured image data, and a second processing part that extracts a second feature point on the basis of the second captured image data. The three-dimensional distance data is generated using at least one of the first feature point and the second feature point.

### TECHNICAL FIELD

The present disclosure relates to a light detection device and a light detection system.

### BACKGROUND ART

A light detection device which has a projector and a camera, and which measures the three-dimensional shape of an object through pattern projection, is known.

### CITATION LIST

### Patent Literature

### PTL 1

Japanese Patent Application No. 2019-506001

### SUMMARY

### Technical Problem

In such a method which measures a three-dimensional shape, the regions to be measured may include a region of a high-reflection material, a region of a low-reflection material, or the like. In such a case, if a projection pattern is projected onto the region to be measured and an image of the projection pattern is then captured, blowouts and blocked-up shadows will occur. For this reason, a plurality of images captured while varying the dynamic range may be composited, and the three-dimensional shape may then be measured after processing for expanding the dynamic range is performed. However, if processing for expanding the dynamic range is performed continually, there is a risk that issues such as an increase in the circuit scale, worse latency, and the like will arise.

Accordingly, the present disclosure provides a light detection device and a light detection system capable of measuring a three-dimensional shape at a higher speed.

### Solution to Problem

To solve the above-described problem, the present disclosure provides a light detection device including:
an image capturing part that captures an image of a measurement range onto which a projected image having a predetermined pattern is projected; and
a signal processing part that generates three-dimensional distance data of the measurement range on the basis of first captured image data of a range that has a first dynamic range captured by the image capturing part, and second captured image data of a range that has a second dynamic range, different from the range of the first dynamic range,
wherein the signal processing part includes:
a first processing part that extracts a first feature point on the basis of the first captured image data; and
a second processing part that extracts a second feature point on the basis of the second captured image data, and
the three-dimensional distance data is generated using at least one of the first feature point and the second feature point.

In a case where the first processing part cannot extract the first feature point, the signal processing part may extract the second feature point from a second region of the second captured image data, the second region corresponding to a first region from which the first feature point cannot be extracted.

In a case where the second processing part cannot extract the second feature point, the signal processing part may extract the first feature point from a first region of the first captured image data, the first region corresponding to a second region from which the second feature point cannot be extracted.

The image capturing part may include:
a plurality of first pixels arranged two-dimensionally; and
a plurality of second pixels arranged two-dimensionally,
the first captured image data may be captured using the plurality of first pixels, and
the second captured image data may be captured using the plurality of second pixels.

An accumulation time of the plurality of first pixels may be configured to be shorter than an accumulation time of the plurality of second pixels.

A sensitivity of the plurality of first pixels may be configured to be lower than a sensitivity of an accumulation time of the plurality of second pixels.

The signal processing part may include:
a first binarization processing part that generates first binarized data based on the first captured image data; and
a second binarization processing part that generates second binarized data based on the second captured image data,
the first processing part may extract the first feature point using the first binarized data, and
the second processing part may extract the second feature point using the second binarized data.

A projection part that projects the projected image may further be included.

The image capturing part may include an image capturing optical system,
the projection part may include a projection optical system, and
an optical axis of the image capturing optical system and an optical axis of the projection optical system may be parallel.

The signal processing part may include:
a first distortion correction part that corrects the first captured image data such that an epipolar line of the first captured image data becomes closer to a straight line; and
a second distortion correction part that corrects the second captured image data such that an epipolar line of the second captured image data becomes closer to a straight line,
the first binarization processing part may generate the first binarized data using captured image data obtained by correcting distortion of the first captured image data, and
the second binarization processing part may generate the first binarized data using captured image data obtained by correcting distortion of the second captured image data.

The first distortion correction part may correct the distortion in accordance with a square of r based on a square of an x coordinate and a square of a y coordinate of the first captured image data, and
the second distortion correction part may correct the distortion in accordance with a square of r based on a square of an x coordinate and a square of a y coordinate of the second captured image data.

The first processing part may extract the first feature point in a first direction on the basis of the first captured image data after the correcting of the distortion, and the second processing part may extract the first feature point in the first direction on the basis of the second captured image data after the correcting of the distortion.

The first feature point extracted in the first direction and the second feature point extracted in the first direction may correspond to optical feature points in the same row direction of the projected image.

The signal processing part may further include:
a distance calculation processing part that generates the three-dimensional distance data on the basis of at least one of the first feature point and the second feature point, using the principle of triangulation.

An accumulation time of the plurality of first pixels and an accumulation time of the plurality of second pixels may be capable of being set by a processing unit that performs control processing using the three-dimensional distance data.

A correction accuracy of the first distortion correction part and the second distortion correction part may be capable of being set by a processing unit that performs control processing using the three-dimensional distance data.

To solve the above-described problem, the present disclosure provides a light detection system including:
a projection device that projects a predetermined projection pattern onto a measurement range through a projection optical system;
an image capturing device that captures an image of the measurement range onto which the projection pattern has been projected through an image capturing optical system; and
a signal processing device that generates three-dimensional distance data of the measurement range on the basis of first captured image data of a range that has a first dynamic range captured by the image capturing device, and second captured image data of a range that has a second dynamic range, different from the range of the first dynamic range,
wherein a signal processing part of the signal processing device includes:
a first processing part that extracts a first feature point on the basis of the first captured image data; and
a second processing part that extracts a second feature point on the basis of the second captured image data, and
the three-dimensional distance data is generated using at least one of the first feature point and the second feature point.

An optical axis of the projection optical system and an optical axis of the image capturing optical system may be parallel, and
the signal processing part may generate one of the first feature point and the second feature point after the first captured image data and the second captured image data are corrected such that an epipolar line of each thereof becomes closer to a straight line.

To solve the above-described problem, the present disclosure provides a light detection system including:
a projection device that projects a predetermined projection pattern onto a measurement range through a projection optical system;
a first image capturing device that captures an image of the measurement range onto which the projection pattern has been projected through a first image capturing optical system; and
a second image capturing device that, captures an image of the measurement range onto which the projection pattern has been projected through a second image capturing optical system,
wherein the second image capturing device includes a signal processing part that:
complementarily extracts one of a first feature point based on first captured image data of a range that has a first dynamic range and a second feature point based on second captured image data of a range that has a second dynamic range, the first captured image data and the second captured image data being captured by the first image capturing device; and
complementarily extracts one of a third feature point based on third captured image data of a range that has a third dynamic range and a fourth feature point based on fourth captured image data of a range that has a fourth dynamic range, the third captured image data and the fourth captured image data being captured by the second image capturing device, and
the signal processing part generates the three-dimensional distance data using at least one of the first feature point, the second feature point, the third feature point, and the fourth feature point.

An optical axis of the first image capturing optical system and an optical axis of the second image capturing optical system may be parallel, and
the signal processing part may generate at least one of the first feature point, the second feature point, the third feature point, and the fourth feature point after correcting the first captured image data, the second captured image data, the third captured image data, and the fourth captured image data such that an epipolar line of each thereof becomes closer to a straight line.

### BRIEF DESCRIPTION OF DRAWINGS

FIG. 1 is a diagram illustrating an example of the overall configuration of a light detection device to which the present technique is applied.

FIG. 2 is a block diagram illustrating an example of the configuration of the light detection device.

FIG. 3 is a block diagram illustrating an example of the configuration of a later-stage processing unit.

FIG. 4 is a diagram conceptually illustrating the flow of processing performed by a distance data calculation part.

FIG. 5 is a diagram illustrating a relationship between coordinates of an image before correction and coordinates after correction.

FIG. 6 is a diagram schematically illustrating an example of processing by a short accumulation image generation part and a long accumulation image generation part.

FIG. 7 is a diagram schematically illustrating complementary processing performed by a short accumulation image feature calculation processing part and a long accumulation image feature calculation processing part.

FIG. 8 is a diagram schematically illustrating an example of processing performed by a distance calculation processing part.

FIG. 9 is a block diagram illustrating an example of the configuration of a light detection device according to a second embodiment.

FIG. 10 is a diagram illustrating an example of the configuration of a light detection system according to a third embodiment.

FIG. 11 is a diagram illustrating an example of the configuration of a light detection system according to a fourth embodiment.

### DESCRIPTION OF EMBODIMENTS

Embodiments of a light detection device and a light detection method will be described hereinafter with reference to the drawings. Although the following descriptions will focus on the main constituent parts of the light detection device and the light detection method, constituent parts and functions that are not illustrated or described can be present in the light detection device and the light detection method. The following descriptions are not intended to exclude constituent parts or functions that are not illustrated or described.

### First Embodiment

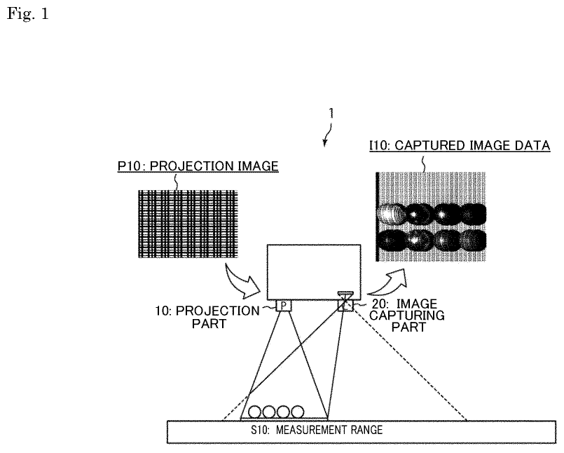

FIG. 1 is a diagram illustrating an example of the overall configuration of a light detection device to which the present technique is applied. A light detection device 1 illustrated in FIG. 1 has at least a projection part 10 and an image capturing part 20, for example. The light detection device 1 can be configured as a smaller-size device, e.g., as a vehicle mounted or portable device.

The projection part 10 is a projector, for example, and generates a projection image P10 having two types of luminance, namely a bright part and a dark part, as a projection pattern, and irradiates a measurement range S10 therewith. The projection image P10 is a lattice pattern, for example, as illustrated in FIG. 1. In this lattice pattern, feature points having unique geometrical shapes are arranged in a two-dimensional lattice shape. In addition, three-dimensional coordinates for a main point position of the projection part 10 are assigned to each feature point in advance. Although the projection image P10 is a lattice pattern, the projection image P10 is not limited thereto. For example, pattern light in which a plurality of spots SP formed by dot shapes arranged at predetermined regular or irregular intervals are taken as bright parts, and other regions are taken as dark parts, may be used. Note that in the present embodiment, the feature points of the projection image P10 may be referred to as “optical feature points”.

The image capturing part 20 is a camera, for example, and captures the projection image P10 in the measurement range S10 as captured image data 110. The light detection device 1 detects the coordinates of the feature points on the captured image I10, and according to the principle of triangulation (described later), generates distance values of the measurement range S10 from the main point position of the projection part 10 or the image capturing part 20 as three-dimensional distance data.

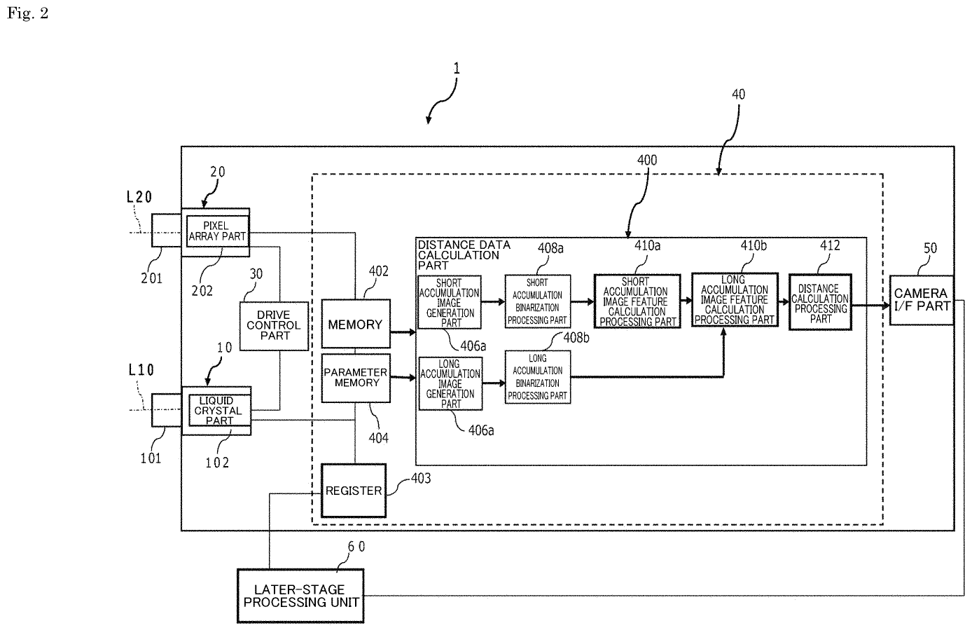

FIG. 2 is a block diagram illustrating an example of the configuration of the light detection device 1. As illustrated in FIG. 2, the light detection device 1 includes the projection part 10, the image capturing part 20, a drive control part 30, a signal processing part 40, a camera interface part 50, and a later-stage processing unit 60.

The projection part 10 includes a projection optical system 101 having an optical axis L10, and a liquid crystal part 102. The liquid crystal part 102 generates the two-dimensional projection image P10 as a luminance image. A position in the projection image P10 in the row direction is taken as an xp coordinate, and a position in the column direction is taken as a yp coordinate. The liquid crystal part 102 generates the projection image P10 as a luminance image using, for example, the raw data of the projection image P10 (see FIG. 1) stored in a memory 402 (described later). Accordingly, as described above, the projection part 10 projects the projection image P10 onto the measurement range S10 through the projection optical system 101.

The image capturing part 20 includes an image capturing optical system 201 having an optical axis L20, and an image array part 202 in which an image sensor is disposed in a two-dimensional shape. The optical axis L10 and the optical axis L20 are parallel. The image array part 202 is a Complementary Metal Oxide Semiconductor (CMOS) image sensor, for example. In the image array part 202, pixels for short accumulation and pixels for long accumulation are arranged in a two-dimensional lattice shape. The light accumulation time when capturing using the pixels for short accumulation is set to be shorter than the light accumulation time when capturing using the pixels for long accumulation. The pixels for short accumulation and pixels for long accumulation have the same total number of pixels, and have mutually-corresponding coordinates. For example, the exposure time when capturing pixels for short accumulation is 3 ms, and the exposure time when capturing pixels for long accumulation is 30 ms.

Accordingly, the image array part 202 captures the projection image P10 (see FIG. 1) in the measurement range S10 through the image capturing optical system 201 to generate short accumulation image data IS100 and long accumulation image data IL100. The dynamic range of the short accumulation image data IS100 is image data having a dynamic range of a first range on the brightness side, and the dynamic range of the short long accumulation image data IL100 is image data having a dynamic range of a second range on the dark part side. The short accumulation image data IS100 according to the present embodiment corresponds to first captured image data, and the long accumulation image data IL100 corresponds to second captured image data.

A position in the row direction of the image array part 202 is taken as an x coordinate, and a position in the column direction is taken as a y coordinate. As will be seen hereafter, the short accumulation image data IS100 is suited to capturing high-brightness images, and the long accumulation image data IL100 is more suited to capturing low-brightness images than the short accumulation image data IS100. In other words, the short accumulation image data IS100 suppresses blowouts, and the long accumulation image data IL100 suppresses blocked-up shadows. Note that “blowouts” are regions in which the pixel values of bright regions are saturated, and “blocked-up shadows” are regions in which the pixel values of dark regions are saturated.

The drive control part 30 is configured including, for example, a Central Processing Unit (CPU). The drive control part 30 controls the projection part 10 and the image capturing part 20 on the basis of input signals from an operation part (not shown), for example.

The signal processing part 40 is configured on one semiconductor substrate, including a Central Processing Unit (CPU), for example. In other words, the signal processing part 40 includes a distance data calculation part 400, the memory 402, a parameter memory 404, and a register 405.

The distance data calculation part 400 calculates three-dimensional distance data using the short accumulation image data IS100 and the long accumulation image data IL 100. In other words, the distance data calculation part 400 includes a short accumulation image generation part 406a, a long accumulation image generation part 406b, a short accumulation binarization signal processing part 408a, a long accumulation binarization signal processing part 408b, a short accumulation image feature calculation processing part 410a, a long accumulation image feature calculation processing part 410b, and a distance calculation processing part 412. The distance data calculation part 400 will be described in detail later. The camera interface part 50 is an interface between the light detection device 1 and the later-stage processing unit 60. In the present embodiment, the short accumulation image generation part 406a corresponds to a first distortion correction part, the long accumulation image generation part 406b corresponds to a second distortion correction part, the short accumulation binarization signal processing part 408a corresponds to a first binarization processing part, the long accumulation binarization signal processing part 408b corresponds to a second binarization processing part, the short accumulation image feature calculation processing part 410a corresponds to a first processing part, and the long accumulation image feature calculation processing part 410b corresponds to a second processing part.

The memory 402 can store a predetermined program of the signal processing part 40, as well as the raw data of the projection image P10 (see FIG. 1) and the captured image data I10. The parameter memory 404 stores the coordinates of each feature point in the projection image P10 and features quantified by the geometric features of each feature point. The main point position of the projection part 10, the main point position of the image capturing part 20, the distance between the main point positions, distortion parameters of the image capturing optical system 201 in the image capturing part 20, and the like, which are necessary for distance calculation (described later), are also stored. In other words, the signal processing part 40 generates a distance value from the main point position of the measurement range S10 by performing signal processing using each item of information stored in the parameter memory 404, in accordance with a program stored in the memory 402.

The register 405 stores processing parameters and the like set in accordance with the processing by the later-stage processing unit. The processing parameters are also stored in the parameter memory 404.

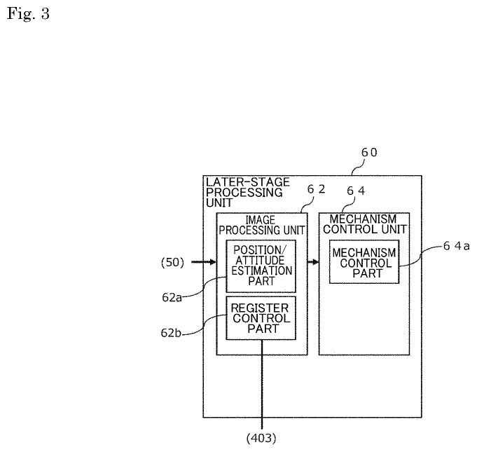

FIG. 3 is a block diagram illustrating an example of the configuration of the later-stage processing unit 60. The later-stage processing unit 60 is a unit that performs processing using the three-dimensional distance data, and includes an image processing unit 62 and a mechanism control unit 64. Furthermore, the image processing unit 62 includes a position/attitude estimation part 62a and a register control part 62b, and the mechanism control unit 64 includes a mechanism control part 64a.

The later-stage processing unit 60 is used, for example, to control a robot arm. The position/attitude estimation part 62a uses the three-dimensional distance data to find the position and attitude of a measurement object, and outputs the obtained information on the position and attitude to the mechanism control part 64a of the mechanism control unit 64. The mechanism control part 64a sends drive commands to the robot arm to control the robot arm on the basis of the information on the position and attitude. The robot arm holds the measurement object using a robot hand or the like at the end of the arm, and moves the measurement object translationally or rotationally.

Before this control, the register control part 62b can set information on the material of the target object for control, distortion correction accuracy, and the like in the register 405 in accordance with the attributes of the target object. In other words, the register control part 62b sets the accumulation time of the short accumulation image data IS100 and the accumulation time of the long accumulation image data IL 100 in the register 405 in accordance with the attributes of the target object for control. In addition, the register control part 62b sets use parameters among distortion parameters k1, k2, and k3, to be used in Formulas (1) and (2) (described later), in the register 405. In other words, the register control part 62b sets the distortion parameters k1, k2, and k3 in the register 405 when highly-accurate control is required, and sets the distortion parameters k1 and k2 in the register 405 when control speed is to be prioritized over positional control.

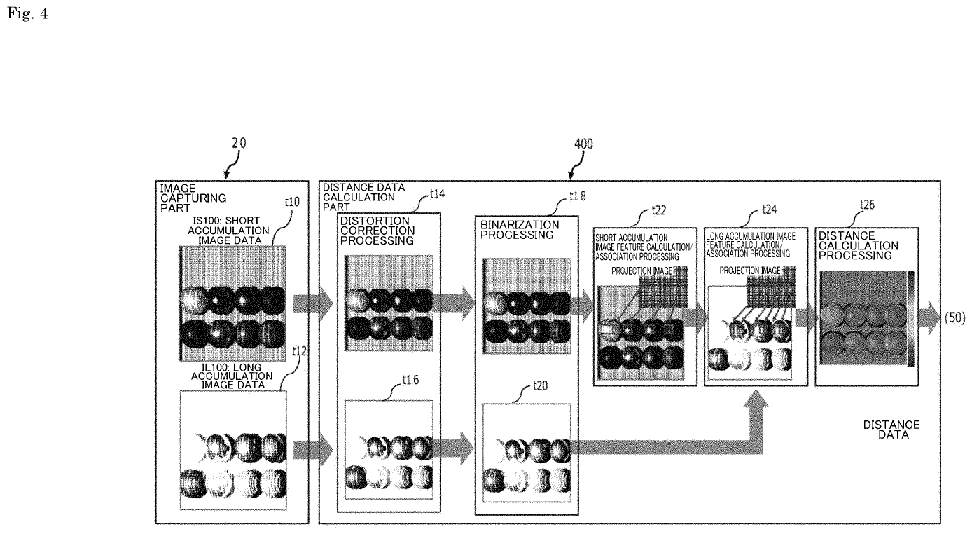

The distance data calculation part 400 will now be described in detail with reference to FIGS. 4 to 8. The distance data calculation part 400 can use feature points based on the short accumulation image data IS100 and feature points based on the long accumulation image data IL100 in a complementary manner.

FIG. 4 is a diagram conceptually illustrating the flow of processing performed by the distance data calculation part 400. Under the control of the drive control part 30, the image capturing part 20 generates the short accumulation image data IS100 and the long accumulation image data IL100 at a timing which causes the accumulation times thereof to overlap (t10, t12). As a result, misalignment between the short accumulation image data IS100 and the long accumulation image data IL100 is suppressed even when the measurement target is moving.

In the distance data calculation part 400, the short accumulation image generation part 406a and the short accumulation binarization signal processing part 408a, and the long accumulation image generation part 406b and the long accumulation binarization signal processing part 408b, can process the short accumulation image data IS100 and the long accumulation image data IL100 in parallel. This makes it possible to shorten the computation speed.

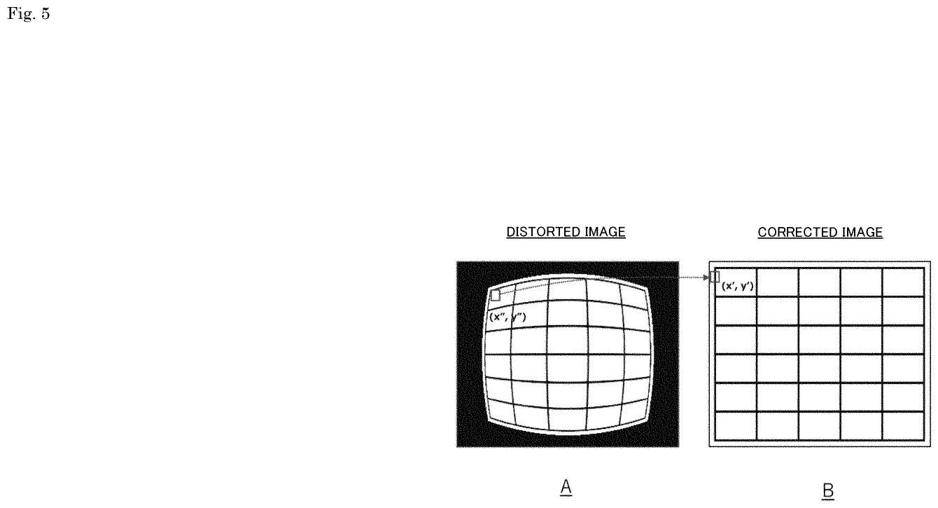

FIG. 5 is a diagram illustrating a relationship between coordinates of an image before correction (x″,y″) and coordinates after correction (x′,y′). A in the figure indicates a distorted image before correction, and B indicates a corrected image after the correction. The parameter memory 404 stores the distortion parameters k1, k2, and k3 of Formulas (1) and (2), for example. The short accumulation image generation part 406a and the long accumulation image generation part 406b perform the distortion correction processing indicated by Formulas (1) to (3) on the short accumulation image data IS100 and the long accumulation image data IL100 (t14, t16). The short accumulation image generation part 406a generates distortion-corrected short accumulation image data IS100a (x′,y′) from the short accumulation image data IS100 (x″,y″). Similarly, the long accumulation image generation part 406b generates distortion corrected long accumulation image data IL100 (x′,y′) from the long accumulation image data IL100a (x″,y″) (t14, t16).

As described above, the short accumulation image generation part 406a and the short accumulation binarization signal processing part 408a set the distortion parameters k1, k2, and k3 used for correction in accordance with control instructions from the register control part 62b (see FIG. 3). For example, the distortion parameters k1, k2, and k3 can be used for highly-accurate processing, whereas the distortion parameters k1 and k2 can be used for lower-accuracy processing. The distortion parameters can be found, for example, through prior calibration using the Zhang method, and are obtained in advance. In addition, the distortion parameters k1, k2, and k3 may be referred to as radial distortion parameters.

[Math. 1]

x′=x″(1+kᵣr²+k₂r⁴+k₃r⁸) (1)

[Math. 2]

y′=y″(1+k₁r²+k₂r⁴+k₃r⁸) (2)

Here,

[Math. 3]

r²=x″²+y″² (3)

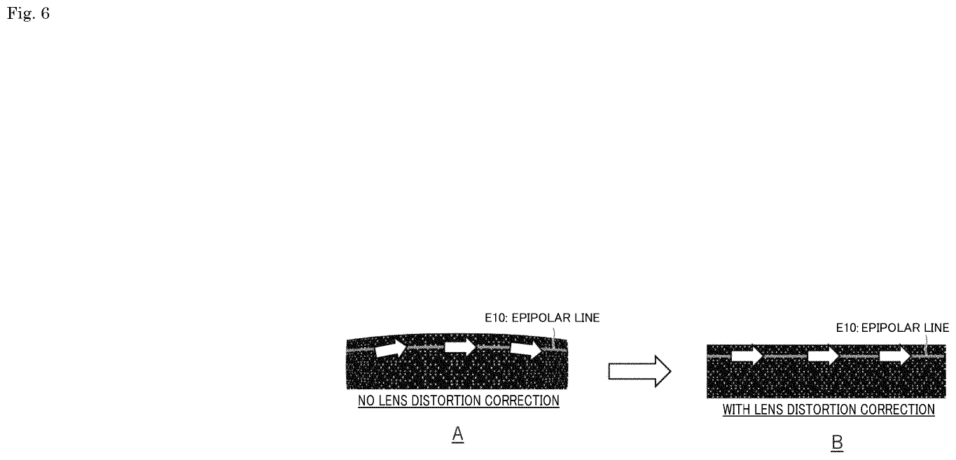

FIG. 6 is a diagram schematically illustrating an example of the processing by the short accumulation image generation part 406a and the long accumulation image generation part 406b. In FIG. 6, A indicates the pre-correction image, and B indicates the corrected image. The optical axes L10 and L20 are parallel, and thus an epipolar line E10 becomes a straight line in the corrected image.

In accordance with a predetermined threshold, the short accumulation binarization signal processing part 408a and the long accumulation binarization signal processing part 408b perform binarization processing on distortion-corrected short accumulation image data IS100b (x′,y′) and long accumulation image data IL100b (x′,y′) to generate short accumulation binarized image data IS100c (x′,y′) and long accumulation binarized image data IL100c (x′,y′) (t18, t20).

Next, the short accumulation image feature calculation processing part 410a extracts feature points (x,y) and calculates features along the row direction of the short accumulation image data IS100c (x′,y′) subjected to the binarization processing. For example, the short accumulation image feature calculation processing part 410a extracts the coordinates of edges as feature points, and calculates the feature using the pixel values around the feature points (t22).

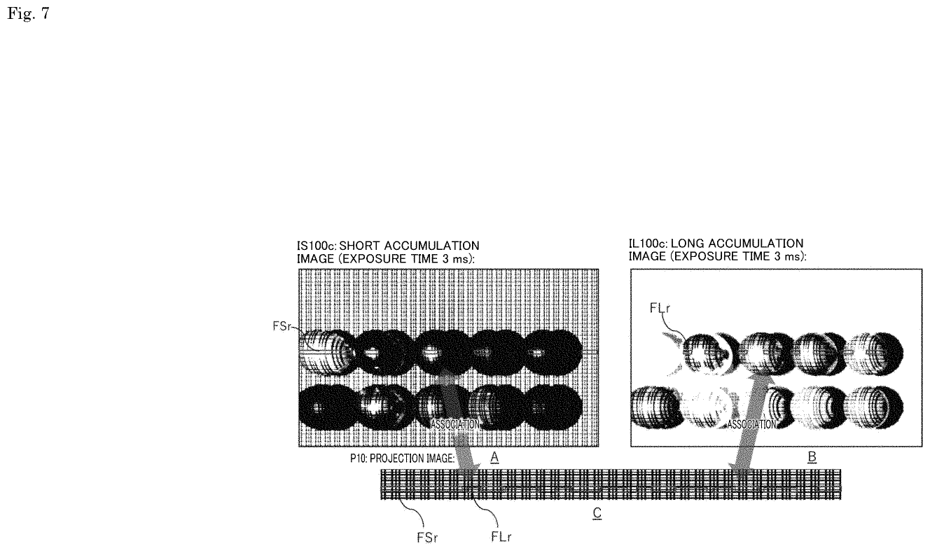

FIG. 7 is a diagram schematically illustrating complementary processing performed by the short accumulation image feature calculation processing part 410a and the long accumulation image feature calculation processing part 410b. A indicates a feature point extraction region FSr for the short accumulation image feature calculation processing part 410a, and B indicates a feature point extraction region FLr for the long accumulation image feature calculation processing part 410b. C indicates the extraction region FSr and the extraction region FLr on the projection image P10 (see FIG. 1).

Due to the difference in the dynamic range between the short accumulation binarized image data IS100c (x′,y′) and the long accumulation binarized image data IL100c (x′,y′), in the short accumulation binarized image data IS100c (x′,y′), blocked-up shadow regions correspond to non-blowout regions in the long accumulation binarized image data IL100c (x′,y′). Similarly, in the long accumulation binarized image data IL 100c (x′,y′), blowout regions correspond to non-blocked-up shadow regions in the short accumulation binarized image data IS100c (x′,y′). In other words, the dynamic range between the short accumulation binarized image data IS100c (x′,y′) and the long accumulation binarized image data IL100c (x′,y′) is set such that in the short accumulation binarized image data IS100c (x′,y′), blocked-up shadow regions correspond to non-blowout regions in the long accumulation binarized image data IL100c (x′,y′).

Accordingly, in regions for which feature points and features could not be calculated by the short accumulation image feature calculation processing part 410a due to blocked-up shadows, the feature points and features are calculated by the long accumulation image feature calculation processing part 410b (t24) (see FIG. 4). Through this, feature points can be extracted in a complementary manner in the row direction, as indicated in C.

In addition, because the epipolar line E10 is corrected to a straight line, the extraction of the feature points by the short accumulation image feature calculation processing part 410a and the long accumulation image feature calculation processing part 410b can be performed linearly in the same direction. Through this, as indicated in C, the coordinates of the optical feature points in the same row direction in the projection image P10 (see FIG. 1) can be associated with the feature points extracted by the short accumulation image feature calculation processing part 410a and the long accumulation image feature calculation processing part 410b. Accordingly, the coordinates of the optical feature points in the same row direction in the projection image P10 (see FIG. 1) can be associated with the feature points from the short accumulation image feature calculation processing part 410a and the long accumulation image feature calculation processing part 410b, more quickly and more accurately.

In addition, for example, if there is no blocked-up shadow region in the short accumulation binarized image data IS100c (x′,y′), only processing by the short accumulation image feature calculation processing part 410a is required, which makes faster calculation possible. Similarly, for example, if there is no blowout region in the long accumulation binarized image data IL100c (x′,y′), only processing by the long accumulation image feature calculation processing part 410b is required, which makes faster calculation possible.

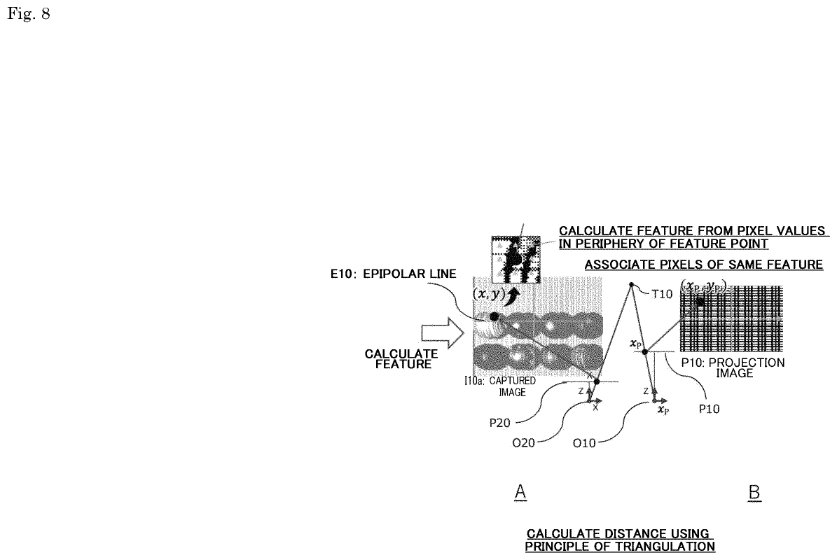

FIG. 8 is a diagram schematically illustrating an example of processing performed by the distance calculation processing part 412. The distance calculation processing part 412 obtains, from the parameter memory 404, coordinates (xp,yp) of the feature points in the projection image P10 corresponding to the feature of the feature points. As illustrated in FIG. 8, the coordinates of a main point position O10 of the projection part 10 and a display plane P10 of the liquid crystal part 102 are known. Similarly, the coordinates of the image array part 202 display plane P20 of the image capturing part 20 are known. Accordingly, three-dimensional coordinates (x,y,z) of the coordinates (x,y) of the feature points and the coordinates (xp,yp) corresponding to the feature points can be generated for the main point position coordinates 010. Furthermore, the distance between the main point positions O10 and O20 is also known. As can be seen from the foregoing, the distance calculation processing part 412 generates three-dimensional distance data of a measurement point T10 through the principle of triangulation using the coordinates (x,y) of the feature points and the coordinates (xp,yp) of the corresponding points (t26) (see FIG. 4). Although the processing by the long accumulation image feature calculation processing part 410b is performed after the short accumulation image feature calculation processing part 410a in the present embodiment, the short accumulation image feature calculation processing part 410a may perform processing after the processing by the long accumulation image feature calculation processing part 410b is performed.

As described above, according to the present embodiment, the short accumulation image feature calculation processing part 410a calculates feature points and features for the short accumulation binarized image data IS100c (x′,y′), and in the region where the feature points and features could not be calculated due to blocked-up shadows, the long accumulation image feature calculation processing part 410b calculates the feature points and features using the long accumulation binarized image data IL 100c (x′,y′). Alternatively, the long accumulation image feature calculation processing part 410b calculates feature points and features for the long accumulation binarized image data IL100c (x′,y′), and in the region where the feature points and features could not be calculated due to blowouts, the short accumulation image feature calculation processing part 410a calculates the feature points and features using the short accumulation binarized image data IS100c (x′,y′). Accordingly, feature points and features that could not be calculated by one of the short accumulation image feature calculation processing part 410a and the long accumulation image feature calculation processing part 410b can be calculated complementarily by the other of the short accumulation image feature calculation processing part 410a and the long accumulation image feature calculation processing part 410b. Accordingly, even if blocked-up shadows arise in the short accumulation captured image data IS100 or blowouts arise in the long accumulation captured image data IL100, the computation amount can be suppressed, and feature points and features can be calculated from the entire range of the captured image data IS100 and IL100.

### Second Embodiment

A light detection device 1 according to a second embodiment differs from the light detection device 1 according to the first embodiment in that pixels having different sensitivities are disposed in an image array part 202a of the image capturing part 20. Differences from the light detection device 1 according to the first embodiment will be described below.

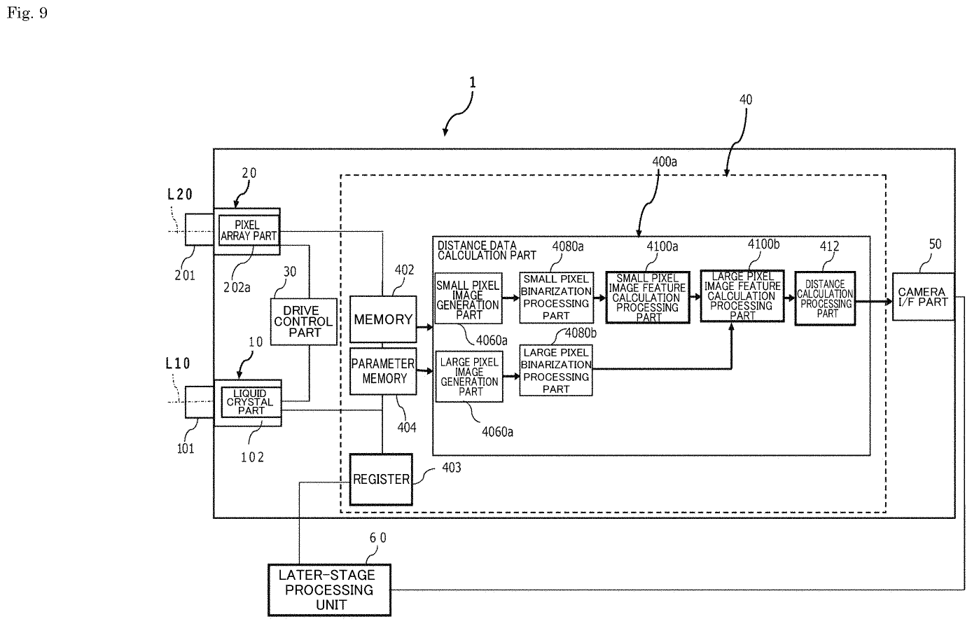

FIG. 9 is a block diagram illustrating an example of the configuration of the light detection device 1 according to the second embodiment. As illustrated in FIG. 9, the image array part 202a has small pixels and large pixels having different sensitivities arranged in a two-dimensional lattice shape. The sensitivity of the small pixels is set to be lower than the sensitivity of the large pixels. The small pixels and the large pixels have the same total number of pixels, and have mutually-corresponding coordinates. Accordingly, blowouts are suppressed in the image data of the small pixels, and blocked-up shadows are suppressed in the image data of the large pixels. For example, the sensitivities of the small pixels and the large pixels can be set according to a light incidence rate of an on-chip lens disposed on each pixel, the numerical aperture of each pixel, the aperture of each pixel, or the like.

A distance data calculation part 400a according to the second embodiment has the same configuration as the optical distance data calculation part 400 according to the first embodiment. In other words, the distance data calculation part 400a according to the second embodiment calculates three-dimensional distance data using small pixel image data ISm100 and large pixel image data IB100. The dynamic range of the small pixel image data ISm100 is image data having a dynamic range of a first range on the brightness side, and the dynamic range of the large pixel image data IB100 is image data having a dynamic range of a second range on the dark part side. The small pixel image data ISm100 according to the present embodiment corresponds to the first captured image data, and the large pixel image data IB100 corresponds to the second captured image data.

In addition, the distance data calculation part 400a includes a small pixel image generation part 4060a, a large pixel image generation part 4060b, a small pixel binarization signal processing part 4080a, a large pixel binarization signal processing part 4080b, a small pixel image feature calculation processing part 4100a, a large pixel image feature calculation processing part 4100b, and the distance calculation processing part 412. In the present embodiment, the small pixel image generation part 4060a corresponds to the first distortion correction part, the large pixel image generation part 4060b corresponds to the second distortion correction part, the small pixel binarization signal processing part 4080a corresponds to the first binarization processing part, the large pixel binarization signal processing part 4080b corresponds to the second binarization processing part, the small pixel image feature calculation processing part 4100a corresponds to the first processing part, and the large pixel image feature calculation processing part 4100b corresponds to the second processing part.

Therefore, according to the present embodiment, the small pixel image feature calculation processing part 4100a calculates feature points and features for small pixel binarized image data ISm100c (x′,y′), and in the region where the feature points and features could not be calculated due to blocked-up shadows, the large pixel feature calculation processing part 4100b calculates the feature points and features using large pixel binarized image data IB100c (x′,y′). Alternatively, the large pixel image feature calculation processing part 4100b calculates feature points and features for the large pixel binarized image data IB100c (x′,y′), and in the region where the feature points and features could not be calculated due to blowouts, the small pixel image feature calculation processing part 4100a calculates the feature points and features using the small pixel binarized image data ISm100c (x′,y′). Accordingly, feature points and features that could not be calculated by one of the small pixel image feature calculation processing part 4100a and the large pixel image feature calculation processing part 4100b can be calculated complementarily by the other of the small pixel image feature calculation processing part 4100a and the large pixel image feature calculation processing part 4100b. Accordingly, even if blocked-up shadows arise in the small pixel captured image data ISm100 or blowouts arise in the large pixel captured image data IB100, the computation amount can be suppressed, and feature points and features can be calculated from the entire range of the captured image data ISm100 and IB100.

### Third Embodiment

A light detection system 1000 according to a third embodiment differs from the light detection device 1 according to the first embodiment in that the light detection device 1 according to the first embodiment is configured as a system. Differences from the light detection device 1 according to the first embodiment will be described below.

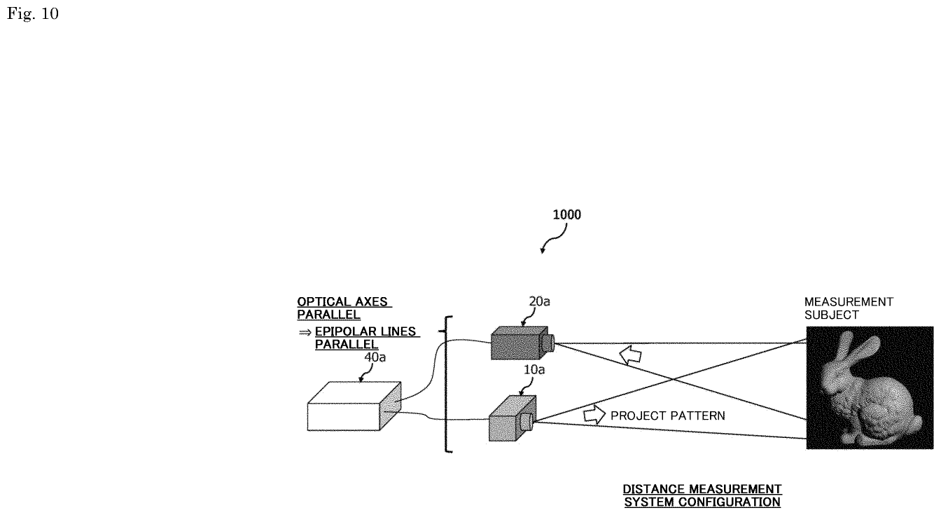

FIG. 10 is a diagram illustrating an example of the configuration of the light detection system 1000 according to the third embodiment. As illustrated in FIG. 10, the light detection system 1000 according to the third embodiment includes a projection device 10a, an image capturing device 20a, and a processing device 40a. The projection device 10a is, for example, a projector, and has a configuration equivalent to that of the projection part 10.

In addition, the image capturing device 20a is a camera, for example, and has a configuration equivalent to that of the image capturing part 20. The processing device 40a is a processor, for example, and has a configuration equivalent to that of the signal processing part 40. In other words, the optical axis of a projection optical system in the projection device 10a and the optical axis of an image capturing optical system in the image capturing device 20a are parallel.

In the processing device 40a, the short accumulation image feature calculation processing part 410a calculates the feature points and features for the short accumulation binarized image data IS100c (x′,y′), and in regions where the feature points and features could not be calculated due to blocked-up shadows, the long accumulation image feature calculation processing part 410b can calculate the feature points and features using the long accumulation binarized image data IL100c (x′,y′). Alternatively, the long accumulation image feature calculation processing part 410b calculates the feature points and features for the long accumulation binarized image data IL100c (x′,y′), and in regions where the feature points and features could not be calculated due to blowouts, the short accumulation image feature calculation processing part 410a can calculate the feature points and features using the short accumulation binarized image data IS100c (x′,y′).

In this manner, in the light detection system 1000, the projection device 10a, the image capturing device 20a, and the processing device 40a can also be configured as independent devices. As a result, the arrangement of the projection device 10a, the image capturing device 20a, and the processing device 40a can be changed freely. In addition, even if blocked-up shadows arise in the short accumulation captured image data IS100 or blowouts arise in the long accumulation captured image data IL100, the computation amount can be suppressed, and feature points and features can be calculated from the entire range of the captured image data IS100 and IL100.

### Fourth Embodiment

Alight detection system 1000a according to a fourth embodiment differs from the light detection system 1000 according to the third embodiment in that an image capturing device 20b enabling images to be captured in stereo is further included. Differences from the light detection system 1000 according to the seventh embodiment will be described below.

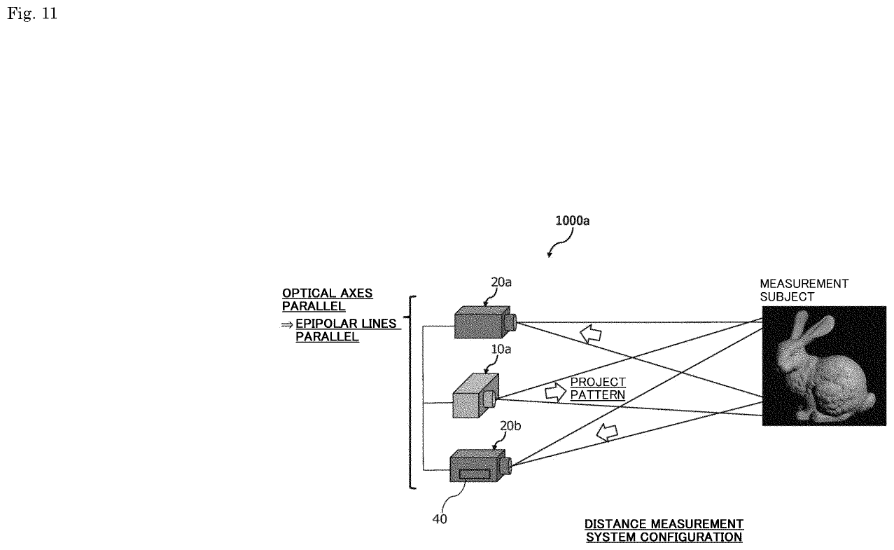

FIG. 11 is a diagram illustrating an example of the configuration of the light detection system 1000a according to the fourth embodiment. As illustrated in FIG. 11, the light detection system 1000a according to the fourth embodiment includes the projection device 10a, the image capturing device 20a, and an image capturing device 20b. The optical axis of the image capturing optical system of the image capturing device 20a is parallel to the optical axis of an image capturing optical system of the image capturing device 20b. In other words, the epipolar lines of the image capturing device 20a and the image capturing device 20b are parallel. The image capturing device 20b also has a configuration equivalent to that of the signal processing part 40. The signal processing part 40 performs distortion correction on image data captured by the image capturing device 20a and the image capturing device 20b, respectively. The signal processing part 40 then generates distance image data using the feature points of each item of the captured image data after the distortion correction.

In other words, in the signal processing part 40, the short accumulation image feature calculation processing part 410a calculates the feature points and features for the short accumulation binarized image data IS100c (x′,y′) from the image capturing device 20a, and in regions where the feature points and features could not be calculated due to blocked-up shadows, the feature points and features can be calculated using the long accumulation binarized image data IL100c (x′,y′) from the image capturing device 20a. Alternatively, in the signal processing part 40, the feature points and features are calculated for the long accumulation binarized image data IL 100c (x′,y′) from the image capturing device 20a, and in regions where the feature points and features could not be calculated due to blowouts, the feature points and features can be calculated using the short accumulation binarized image data IS100c (x′,y′) from the image capturing device 20a.

Similarly, in the signal processing part 40, the short accumulation image feature calculation processing part 410a calculates the feature points and features for the short accumulation binarized image data IS100c (x′,y′) from the image capturing device 20b, and in regions where the feature points and features could not be calculated due to blocked-up shadows, the feature points and features can be calculated using the long accumulation binarized image data IL100c (x′,y′) from the image capturing device 20b. Alternatively, the feature points and features are calculated for the long accumulation binarized image data IL100c (x′,y′) from the image capturing device 20b, and in regions where the feature points and features could not be calculated due to blowouts, the short accumulation image feature calculation processing part 410a of the image capturing device 20b can calculate the feature points and features using the short accumulation binarized image data IS100c (x′,y′) from the image capturing device 20b.

In this manner, even with the light detection system 1000a in which the image capturing device 20a and the image capturing device 20b are configured independently, even if blocked-up shadows arise in the short accumulation captured image data IS100 from the image capturing device 20a and the image capturing device 20b, or blowouts arise in the long accumulation captured image data IL100, the computation amount can be suppressed, and feature points and features can be calculated from the entire range of the captured image data IS100 and IL100.

The present technique can also take on the following configurations.
(1)

A light detection device including:
an image capturing part that captures an image of a measurement range onto which a projected image having a predetermined pattern is projected; and
a signal processing part that generates three-dimensional distance data of the measurement range on the basis of first captured image data of a range that has a first dynamic range captured by the image capturing part, and second captured image data of a range that has a second dynamic range, different from the range of the first dynamic range,
wherein the signal processing part includes:
a first processing part that extracts a first feature point on the basis of the first captured image data; and
a second processing part that extracts a second feature point on the basis of the second captured image data, and
the three-dimensional distance data is generated using at least one of the first feature point and the second feature point.
(2)

The light detection device according to (1),
wherein in a case where the first processing part cannot extract the first feature point, the signal processing part extracts the second feature point from a second region of the second captured image data, the second region corresponding to a first region from which the first feature point cannot be extracted.
(3)

The light detection device according to (1),
wherein in a case where the second processing part cannot extract the second feature point, the signal processing part extracts the first feature point from a first region of the first captured image data, the first region corresponding to a second region from which the second feature point cannot be extracted.
(4)

The light detection device according to (2),
wherein the image capturing part includes:
a plurality of first pixels arranged two-dimensionally; and
a plurality of second pixels arranged two-dimensionally,
the first captured image data is captured using the plurality of first pixels, and
the second captured image data is captured using the plurality of second pixels.
(5)

The light detection device according to (4),
wherein an accumulation time of the plurality of first pixels is configured to be shorter than an accumulation time of the plurality of second pixels.
(6)

The light detection device according to (4),
wherein a sensitivity of the plurality of first pixels is configured to be lower than a sensitivity of an accumulation time of the plurality of second pixels.
(7)

The light detection device according to (5) or (6),
wherein the signal processing part includes:
a first binarization processing part that generates first binarized data based on the first captured image data; and
a second binarization processing part that generates second binarized data based on the second captured image data,
the first processing part extracts the first feature point using the first binarized data, and
the second processing part extracts the second feature point using the second binarized data.
(8)

The light detection device according to (7), further including:
a projection part that projects the projected image.
(9)

The light detection device according to (8),
wherein the image capturing part includes an image capturing optical system, the projection part includes a projection optical system, and
an optical axis of the image capturing optical system and an optical axis of the projection optical system are parallel.
(10)

The light detection device according to (9),
wherein the signal processing part includes:
a first distortion correction part that corrects the first captured image data such that an epipolar line of the first captured image data becomes closer to a straight line; and
a second distortion correction part that corrects the second captured image data such that an epipolar line of the second captured image data becomes closer to a straight line,
the first binarization processing part generates the first binarized data using captured image data obtained by correcting distortion of the first captured image data, and
the second binarization processing part generates the first binarized data using captured image data obtained by correcting distortion of the second captured image data.
(11)

The light detection device according to (10),
wherein the first distortion correction part corrects the distortion in accordance with a square of r based on a square of an x coordinate and a square of a y coordinate of the first captured image data, and
the second distortion correction part corrects the distortion in accordance with a square of r based on a square of an x coordinate and a square of a y coordinate of the second captured image data.
(12)

The light detection device according to (11),
wherein the first processing part extracts the first feature point in a first direction on the basis of the first captured image data after the correcting of the distortion, and
the second processing part extracts the first feature point in the first direction on the basis of the second captured image data after the correcting of the distortion.
(13)

The light detection device according to (12),
wherein the first feature point extracted in the first direction and the second feature point extracted in the first direction correspond to optical feature points in the same row direction of the projected image.
(14)

The light detection device according to (13),
wherein the signal processing part further includes:
a distance calculation processing part that generates the three-dimensional distance data on the basis of at least one of the first feature point and the second feature point, using the principle of triangulation.
(15)

The light detection device according to (5),
wherein an accumulation time of the plurality of first pixels and an accumulation time of the plurality of second pixels can be set by a processing unit that performs control processing using the three-dimensional distance data.
(16)

The light detection device according to (11),
wherein a correction accuracy of the first distortion correction part and the second distortion correction part can be set by a processing unit that performs control processing using the three-dimensional distance data.
(17)

A light detection system including:
a projection device that projects a predetermined projection pattern onto a measurement range through a projection optical system;
an image capturing device that captures an image of the measurement range onto which the projection pattern has been projected through an image capturing optical system; and
a signal processing device that generates three-dimensional distance data of the measurement range on the basis of first captured image data of a range that has a first dynamic range captured by the image capturing device, and second captured image data of a range that has a second dynamic range, different from the range of the first dynamic range,
wherein a signal processing part of the signal processing device includes:
a first processing part that extracts a first feature point on the basis of the first captured image data; and
a second processing part that extracts a second feature point on the basis of the second captured image data, and
the three-dimensional distance data is generated using at least one of the first feature point and the second feature point.
(18)

The light detection system according to (17),
wherein an optical axis of the projection optical system and an optical axis of the image capturing optical system are parallel, and
the signal processing part generates one of the first feature point and the second feature point after the first captured image data and the second captured image data are corrected such that an epipolar line of each thereof becomes closer to a straight line.
(19)

A light detection system including:
a projection device that projects a predetermined projection pattern onto a measurement range through a projection optical system;
a first image capturing device that captures an image of the measurement range onto which the projection pattern has been projected through a first image capturing optical system; and
a second image capturing device that captures an image of the measurement range onto which the projection pattern has been projected through a second image capturing optical system,
wherein the second image capturing device includes a signal processing part that:
complementarily extracts one of a first feature point based on first captured image data of a range that has a first dynamic range and a second feature point based on second captured image data of a range that has a second dynamic range, the first captured image data and the second captured image data being captured by the first image capturing device; and
complementarily extracts one of a third feature point based on third captured image data of a range that has a third dynamic range and a fourth feature point based on fourth captured image data of a range that has a fourth dynamic range, the third captured image data and the fourth captured image data being captured by the second image capturing device, and
the signal processing part generates the three-dimensional distance data using at least one of the first feature point, the second feature point, the third feature point, and the fourth feature point.
(20)

The light detection system according to (19),
wherein an optical axis of the first image capturing optical system and an optical axis of the second image capturing optical system are parallel, and
the signal processing part generates at least one of the first feature point, the second feature point, the third feature point, and the fourth feature point after correcting the first captured image data, the second captured image data, the third captured image data, and the fourth captured image data such that an epipolar line of each thereof becomes closer to a straight line.

Aspects of the present disclosure are not limited to the aforementioned individual embodiments and include various modifications that those skilled in the art can achieve, and the effects of the present disclosure are also not limited to the details described above. In other words, various additions, modifications, and partial deletions can be made without departing from the conceptual ideas and spirit of the present disclosure that can be derived from the details defined in the claims and the equivalents thereof.

### REFERENCE SIGNS LIST

1 Light detection device
10 Projection part
10a Projection device
20 Image capturing part
20a, 20b Image capturing device
40 Signal processing part
60 Later-stage processing unit
43 Signal processing part
51 Display device
16 Infrared light pulse laser
20 Control part
24 Display device
430 Image generation part
432 Pattern detection part
434 Determination part
436 First distance generation part
101 Projection optical system
201 Image capturing optical system
400, 400a Distance data calculation part
406a Short accumulation image generation part
406b Long accumulation image generation part
408a Short accumulation binarization signal processing part
408b Long accumulation binarization signal processing part
410a Short accumulation image feature calculation processing part
410b Long accumulation image feature calculation processing part
412 Distance calculation processing part
1000 Light detection system
4060a Small pixel image generation part
4060b Large pixel image generation part
4080a Small pixel binarization signal processing part
4080b Large pixel binarization signal processing part
4100a Small pixel image feature calculation processing part
4100b Large pixel image feature calculation processing part
IS100 Short accumulation image data
IL100 Long accumulation image data

1. A light detection device comprising:
an image capturing part that captures an image of a measurement range onto which a projected image having a predetermined pattern is projected; and
a signal processing part that generates three-dimensional distance data of the measurement range on the basis of first captured image data of a range that has a first dynamic range captured by the image capturing part, and second captured image data of a range that has a second dynamic range, different from the range of the first dynamic range,
wherein the signal processing part includes:
a first processing part that extracts a first feature point on the basis of the first captured image data; and
a second processing part that extracts a second feature point on the basis of the second captured image data, and
the three-dimensional distance data is generated using at least one of the first feature point and the second feature point.

2. The light detection device according to claim 1,
wherein in a case where the first processing part cannot extract the first feature point, the signal processing part extracts the second feature point from a second region of the second captured image data, the second region corresponding to a first region from which the first feature point cannot be extracted.

3. The light detection device according to claim 1,
wherein in a case where the second processing part cannot extract the second feature point, the signal processing part extracts the first feature point from a first region of the first captured image data, the first region corresponding to a second region from which the second feature point cannot be extracted.

4. The light detection device according to claim 2,
wherein the image capturing part includes:
a plurality of first pixels arranged two-dimensionally; and
a plurality of second pixels arranged two-dimensionally,
the first captured image data is captured using the plurality of first pixels, and
the second captured image data is captured using the plurality of second pixels.

5. The light detection device according to claim 4,
wherein an accumulation time of the plurality of first pixels is configured to be shorter than an accumulation time of the plurality of second pixels.

6. The light detection device according to claim 4,
wherein a sensitivity of the plurality of first pixels is configured to be lower than a sensitivity of an accumulation time of the plurality of second pixels.

7. The light detection device according to claim 5,
wherein the signal processing part includes:
a first binarization processing part that generates first binarized data based on the first captured image data; and
a second binarization processing part that generates second binarized data based on the second captured image data,
the first processing part extracts the first feature point using the first binarized data, and
the second processing part extracts the second feature point using the second binarized data.

8. The light detection device according to claim 7, further comprising:
a projection part that projects the projected image.

9. The light detection device according to claim 8,
wherein the image capturing part includes an image capturing optical system, the projection part includes a projection optical system, and
an optical axis of the image capturing optical system and an optical axis of the projection optical system are parallel.

10. The light detection device according to claim 9,
wherein the signal processing part includes:
a first distortion correction part that corrects the first captured image data such that an epipolar line of the first captured image data becomes closer to a straight line; and
a second distortion correction part that corrects the second captured image data such that an epipolar line of the second captured image data becomes closer to a straight line,
the first binarization processing part generates the first binarized data using captured image data obtained by correcting distortion of the first captured image data, and
the second binarization processing part generates the first binarized data using captured image data obtained by correcting distortion of the second captured image data.

11. The light detection device according to claim 10,
wherein the first distortion correction part corrects the distortion in accordance with a square of r based on a square of an x coordinate and a square of a y coordinate of the first captured image data, and
the second distortion correction part corrects the distortion in accordance with a square of r based on a square of an x coordinate and a square of a y coordinate of the second captured image data.

12. The light detection device according to claim 11,
wherein the first processing part extracts the first feature point in a first direction on the basis of the first captured image data after the correcting of the distortion, and
the second processing part extracts the first feature point in the first direction on the basis of the second captured image data after the correcting of the distortion.

13. The light detection device according to claim 12,
wherein the first feature point extracted in the first direction and the second feature point extracted in the first direction correspond to optical feature points in the same row direction of the projected image.

14. The light detection device according to claim 13,
wherein the signal processing part further includes:
a distance calculation processing part that generates the three-dimensional distance data on the basis of at least one of the first feature point and the second feature point, using the principle of triangulation.

15. The light detection device according to claim 5,
wherein an accumulation time of the plurality of first pixels and an accumulation time of the plurality of second pixels can be set by a processing unit that performs control processing using the three-dimensional distance data.

16. The light detection device according to claim 11,
wherein a correction accuracy of the first distortion correction part and the second distortion correction part can be set by a processing unit that performs control processing using the three-dimensional distance data.

17. A light detection system comprising:
a projection device that projects a predetermined projection pattern onto a measurement range through a projection optical system;
an image capturing device that captures an image of the measurement range onto which the projection pattern has been projected through an image capturing optical system; and
a signal processing device that generates three-dimensional distance data of the measurement range on the basis of first captured image data of a range that has a first dynamic range captured by the image capturing device, and second captured image data of a range that has a second dynamic range, different from the range of the first dynamic range,
wherein a signal processing part of the signal processing device includes:
a first processing part that extracts a first feature point on the basis of the first captured image data; and
a second processing part that extracts a second feature point on the basis of the second captured image data, and
the three-dimensional distance data is generated using at least one of the first feature point and the second feature point.

18. The light detection system according to claim 17,
wherein an optical axis of the projection optical system and an optical axis of the image capturing optical system are parallel, and
the signal processing part generates one of the first feature point and the second feature point after the first captured image data and the second captured image data are corrected such that an epipolar line of each thereof becomes closer to a straight line.

19. A light detection system comprising:
a projection device that projects a predetermined projection pattern onto a measurement range through a projection optical system;
a first image capturing device that captures an image of the measurement range onto which the projection pattern has been projected through a first image capturing optical system; and
a second image capturing device that captures an image of the measurement range onto which the projection pattern has been projected through a second image capturing optical system,
wherein the second image capturing device includes a signal processing part that:
complementarily extracts one of a first feature point based on first captured image data of a range that has a first dynamic range and a second feature point based on second captured image data of a range that has a second dynamic range, the first captured image data and the second captured image data being captured by the first image capturing device; and
complementarily extracts one of a third feature point based on third captured image data of a range that has a third dynamic range and a fourth feature point based on fourth captured image data of a range that has a fourth dynamic range, the third captured image data and the fourth captured image data being captured by the second image capturing device, and
the signal processing part generates the three-dimensional distance data using at least one of the first feature point, the second feature point, the third feature point, and the fourth feature point.

20. The light detection system according to claim 19,
wherein an optical axis of the first image capturing optical system and an optical axis of the second image capturing optical system are parallel, and
the signal processing part generates at least one of the first feature point, the second feature point, the third feature point, and the fourth feature point after correcting the first captured image data, the second captured image data, the third captured image data, and the fourth captured image data such that an epipolar line of each thereof becomes closer to a straight line.
